(19) United States
(12) Patent Application Publication
(10) Pub. No.: US 2005/0140202 A1
(43) Pub. Date: Jun. 30, 2005

(54) Wheel, wheel disc, and method of manufacturing same

(76) Inventor: Flavio Rodrigues, Limeira-Sao Paulo (BR)

Correspondence Address: CARLSON, GASKEY & OLDS, P.C., 400 WEST MAPLE ROAD, SUITE 350, BIRMINGHAM, MI, 48009, US

(21) Appl. No.: 11/021,550

(22) Filed: Dec. 22, 2004

(30) Foreign Application Priority Data
Dec. 23, 2003 (BR) PI0305977-4

(51) Int. Cl. B60B 3/10

(52) U.S. Cl. 301/95.101

(57) ABSTRACT

The present invention relates to a wheel, particularly for use on vehicles, comprising a substantially cylindrical wheel rim and a substantially cylindrical wheel disc. The wheel rim is concentrically associated to the wheel disc and comprises a flange around its perimeter. The wheel rim has a cylindrical wall provided with two opposite ends, wherein a first end is a first end region and the second end is a second end region. The two end regions are substantially in the form of a flange and throughout the extension of the wheel rim. The flange and the second end region define a groove. The wheel includes a flange that has a first recess, wherein the wheel rim is associated to the wheel disc by positioning the first end region in the first recess. The wheel rim is secured to the wheel disc by at least one attaching element, such as a weld fillet, facing the inside of the groove.

### REFERENCE TO RELATED APPLICATIONS

The present invention claims the benefit of Brazilian Patent Application No. PI10305977-4, filed on Dec. 23, 2003.

### TECHNICAL FIELD

The present invention relates to a wheel, particularly for use on automotive vehicles, that provides greater protection for its attachment structure than conventional wheels the invention is also directed to a wheel disc for use on the inventive wheel and a process for manufacturing the inventive wheel.

### BACKGROUND OF THE INVENTION

Wheels used in vehicles, particularly automotive vehicles, may be classified into two main types according to the process used to manufacture them. Stamped wheels are made from a material in a stamping process, and cast wheels are made from light-metal alloys by a casting process.

Stamped wheels, despite being easy to manufacture and having a low unit cost, have the drawback of not being attractive. As a result, use of stamped wheels is often limited to, for example, low-cost vehicles or utility/commercial vehicles, in which the aesthetics of the wheel is not important. On the other hand, wheels cast from light metal have greater flexibility with respect to possible designs and variations, making them aesthetically more attractive. However, cast wheels come with a high and generally cost-prohibitive price for some portions of the automotive market (for example, popular-priced and utility vehicles).

Prior art wheels made from a stamped material (usually carbon steel) comprise a substantially cylindrical or truncated cone-shaped rim and a substantially circular wheel disc rigidly associated to each other, usually by welding, although one sometimes uses screwing, riveting, etc.

Stamped wheels may be classified in two types, according to the constructive form. A first type of stamped wheel is formed by a rim provided with two opposite end regions, or flanges, which define the region where the wheel diameter is at its maximum. The flanges are protuberant, have a substantially U-shaped or J-shaped curved profile and define a groove for fixing a tire. These wheels are considered conventional stamped wheels. A second type of stamped wheel comprises a rim provided with only one wheel flange, with the other flange being an integral part of the wheel disc. Like the flanges in the first type of stamped wheel, the disc flange and the rim flange in this type of stamped wheel define the region where the wheel diameter is at its maximum; thus, the disc defines, at its flange, the wheel diameter. These wheels are known as integrated wheels and has the advantage of making more attractive and elaborate designs possible while keeping manufacturing costs low.

The stamped wheels of the prior art have some drawbacks in both its manufacture and its use thereof, as explained below in greater detail. As already noted, the manufacture of wheels from a stamped material is carried out by fixing the rim and the wheel disc. The attachment requires the step of making the elements that form the wheel symmetric and centralized. Centralizing the wheel disc and the rim requires precision because any errors in centering the wheel disc and rim may result in one or several defective wheels, causing loss of profit and of valuable time in the production line during manufacturing.

It is perfectly foreseeable that an error in the machinery or even a human error in centralizing the wheels may occur; thus, steps should be taken in anticipation of these errors to reduce their occurrence. This precision in the step of centralizing the wheel rim and disc causes the unit price of the wheel to rise because the centralizing process requires specific machinery as well as skilled labor. This increase is minor, but any additional cost in the process of manufacturing a product should be avoided.

The attachment of the rim and the wheel disc, regardless of whether it is attached by riveting, welding or screwing, is exposed to external agents, such as air, animal excrement, water, etc. Over time, this exposure may cause deterioration of fixing elements, weakening the attachment undesirably. Various protection solutions have been proposed, such as wheel caps that protect the attachment and that also improve the wheel design. However, wheel caps have drawbacks, such as their additional cost, fragility, and ease in being attached and detached from the wheel, making them easy targets for thefts.

There is a desire for a stamped wheel having an attachment between its rim and disc that does not undergo exposure to environmental condition that may accelerate the deterioration process of the attachment and that can be made with an improved manufacturing process, thus reducing cost.

### SUMMARY OF THE INVENTION

A first objective of the invention is to provide a wheel, particularly for use on vehicles, where the configuration of an attachment region between the wheel disc and the wheel rim is protected from environmental conditions so that it will not undergo external damage over time.

A second objective of the present invention is to provide a wheel disc having a recess for attachment of the wheel rim and for providing protection so that the attachment with the wheel rim will not suffer external damage over time.

A third objective of the present invention is to provide a process of manufacturing a wheel having the above-described characteristics.

The inventive wheel has various advantages, including protection of the attachment between the wheel rim and the wheel disc of the present invention against external environmental agents, such as air, water, animal excrement, etc., easy centering of the wheel disc with respect to the wheel rim during manufacturing of the wheel, providing a specified place for applying welding or other means of attaching the wheel disc to the wheel rim, thus facilitating the assembly thereof, improvement in the appearance of the wheel because the attachment is not exposed, and eliminating the need for painting/surface finishing of the attachment so that it will be uniform with the coloration of the wheel because the attachment will not be visible when the wheel is used.

### BRIEF DESCRIPTION OF THE DRAWINGS

The present invention will now be described in greater detail with reference to an embodiment represented in the drawings. In the figures:

FIG. 1 is a perspective view of the wheel of the present invention;

FIG. 2 is a cross-section view of the wheel of the present invention;

FIG. 3 is a cross-section schematic view of the wheel illustrated in FIGS. 1 and 2, showing the wheel rim and the wheel disc before association;

FIG. 4 is a cross-section schematic view of the wheel illustrated in FIGS. 1 and 2, showing the wheel rim and the wheel disc associated, ready for attachment; and

FIG. 5 is a cross-section schematic view of the wheel illustrated in FIGS. 1 and 2 of the present invention, with the rim and disc attached to each other.

### DETAILED DESCRIPTION OF THE DRAWINGS

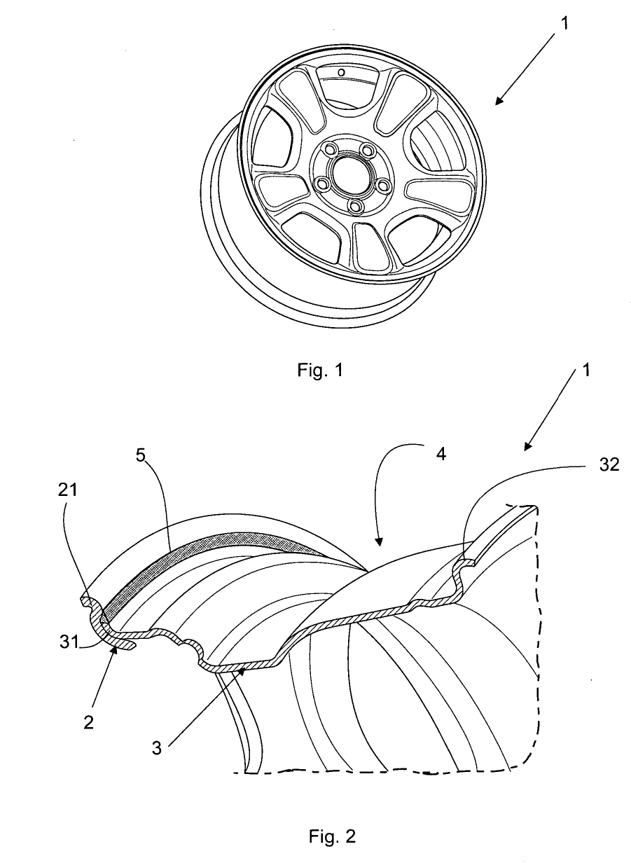

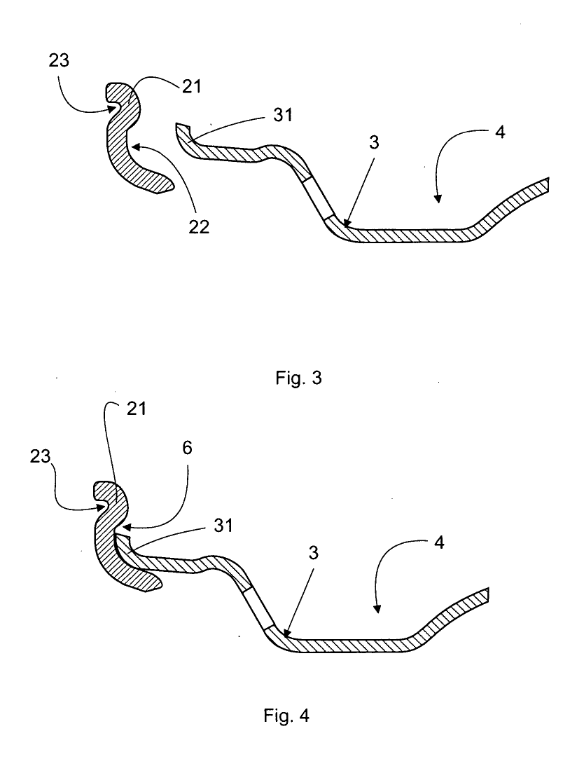

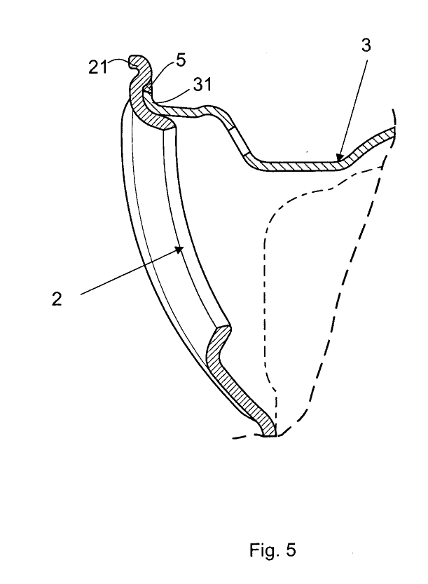

Referring to FIG. 1, the wheel 1 of the present invention comprises a substantially cylindrical wheel 3 and a substantially circular wheel disc 2. The wheel disc 2 is concentrically associated to the wheel rim 3. The cylindrical wheel rim 3 comprises a cylindrical wall having two opposite ends, where a first end is a first end region 31 and a second end is a second end region 32, preferably in the form of a flange. The first and second end regions 31, 32 extend along the extension of the wheel rim 3.

The wheel disc 2 has an end portion in the form of a substantially S-shaped flange 21, which configures a first recess 22 facing the inside of the wheel 1 and a second recess 23 facing the outside of the wheel 1. The flange 21, as well as the first and the second recess 22, 23, extend along the perimeter of the wheel disc 2. Moreover, it is important to emphasize that the wheel disc 2 enables easy installation of common balancing weights in the second recess 23.

Preferably, the wheel disc 2 and the wheel rim 3 are made from carbon steel, but they may be manufactured from any material as long as it is functional and follow the teachings of the present invention.

The wheel rim 3 is associated or otherwise attached to the wheel disc 2 by positioning the first end region 31 in the first recess 22. By positioning the first end region 31 in the first recess 22, the flange 21 and the second end regions 32 (which is also a flange) configure a groove 4 for positioning a tire (not shown). The recess 22 faces the inside of the groove 4; that is, the recess 22 is directed to the side where the tire will be positioned.

In one embodiment, the positioning of the first end region 31 in the recess 22 further defines a recess-shaped attachment region 6 located between the first end region 31 and the flange 21. The attachment region 6 extends throughout the extension of the wheel 1. The attachment region 6 enables one to apply a fixation element. In one embodiment, the fixation element may be, for example, at least one weld fillet 5. The weld fillet 5 is applied so that it remains with its surface equally parallel to the flange 21 and to the first end region 31. For this purpose, the weld fillet 5 may be machined or undergo any other surface finish so that there will be no imperfections on its surface.

Any imperfections in the weld fillet 5 should be removed because they might cause the air contained in a tubeless tire (which are most commonly used today) to escape when the tire is installed/running because the tire bead of the tire comes into contact with the whole surface of the weld fillet 5. This contact with the whole surface of the weld fillet 5 protects the weld fillet 5 against external environmental agents, such as air, animal excrement, water, etc. This long, extended exposure may cause deterioration of the attaching element (e.g. the weld fillet 5), which may cause weakening in this attachment; these drawbacks are eliminated by the inventive structure.

It should be noted that any other type of attachment such as, for example, riveting, screwing, screw-nuts, etc., may be used in place of the weld fillet 5. If the attachment is conducted by means of screws or rivets, the wheel disc 2 is provided with a cavity for receiving the tip of the screw/nut/rivet and the wheel rim 3. More precisely, the first end region 31 is provided with throughbores having a shape identical to the shape of the respective screw/nut/rivet end in order to prevent imperfections on the surface that will contact the wheel bead, preventing air contained in the tire from escaping. However, in this embodiment the existence of the attachment region 6 is not required. The first end region 31 of the wheel rim 3 is shaped to correspond to the recess 22, as already explained above, thus preventing imperfections on the surface that will contact the wheel 1.

This protection of the attaching element, such as the weld fillet 5, between the wheel rim 3 and the wheel disc 2 against external environmental agents such as air, water, etc., prevents weakening of the attaching element and thereby prevents it from breaking, which might cause the wheel rim 3 to detach from the wheel disc 2.

Additionally, by positioning the first end region 31 in the recess 22, the wheel rim 3 can easily be centered with respect to the wheel disc 2 in the manufacturing process of the wheel 1, reducing the time spent at the production line as well as reducing the labor required for such centering and error in this operation.

In the preferred embodiment, the positioning of the first end region 31 in the recess 22 delimits a specified place (i.e., the attachment region 6) for insertion of the weld fillet 5 or other means for attaching the wheel disc 2 to the wheel rim 3, thus incrementing the speed and productivity in the production line.

The present invention improves the visual appearance of the wheel 1 because the attachment of the wheel disc 2 to the wheel rim 3 is not visible. Thus, there is no need to paint the attaching element 5 so that it will have its coloration uniform and in harmony with the color of the wheel 1.

In addition, the wheel disc 2 may be provided separately from the wheel rim 3, and the wheel rim which is to be positioned close to this wheel disc 2 may be shaped in such a manner that it will be attachable by following the teachings of the present invention.

The wheel disc 2 by itself is a new invention having an inventive step and is protected by the accompanying claims. Moreover, the wheel 1 as defined above is obtained by means of a new and inventive manufacturing process comprising the following steps:

Step (i): manufacture of the wheel rim 3;

Step (ii): manufacture of the wheel disc 2;

Step (iii): positioning and associating the wheel rim 3 and the wheel disc 2;

Step (iv): finishing the surface of the attaching element, such as the weld fillet 5; and

Step (v): painting the wheel 1.

Step (i) corresponds to the manufacture of the wheel rim 3, which is preferably made from carbon steel using a rolling process.

The step (ii) corresponds to the manufacture of the wheel disc 2, which is preferably made from carbon steel using a stamping process.

Of course, both step (i) and step (ii) may vary because the materials used for manufacturing the wheel disc 2 and the wheel rim 3 may be different, as already mentioned before. In the same way, the step of manufacturing the wheel rim 3 does not need to be conducted prior to the step of manufacturing the wheel disc 2 because they are independent manufacturing processes.

Step (iii) corresponds to the concentric positioning and association between the wheel rim 3 and the wheel disc 2, thereby configuring the wheel 1 properly. In the preferred embodiment of the invention, the rim 3 and the disc 2 are welded but, as mentioned before, the manner of associating the rim 3 and the disc 2 may be different, for instance by screwing, riveting, etc.

In this step, the facilitated concentric positioning of the first end region 31 in the recess 22 occurs, allowing the flange 21 and the second end region 32 to configure a groove 4 for positioning a tire.

After positioning the first end region 31 concentrically in the recess 22, the wheel rim 3 is attached to the wheel disc 2 by means of an attaching element 5. In one embodiment, the attaching element is a weld fillet.

After the application of the weld fillet 5, there is a step (iv) in which the weld fillet 5 is machined or undergoes any type of surface finish so that there will be no imperfections on the surface of the weld fillet 5.

After step (iv), the wheel 1 goes through an optional painting step (v), which may be omitted, since the weld fillet 5 does not remain visible, as already explained before.

A preferred embodiment having been described, it should be understood that the scope of the present invention embraces other possible variations, being limited only by the contents of the accompanying claims, which include the possible equivalents.

1. A vehicle wheel, comprising:
a substantially cylindrical wheel rim, the wheel rim comprising a cylindrical wall and having two opposite ends that are each substantially in the form of a rim flange, the first end being a first end region and the second end being a second end region, wherein the first end region and the second end region extend throughout the extension of the wheel rim;
a substantially circular wheel disc comprising a wheel flange around its perimeter, wherein the wheel rim is concentrically associated with the wheel disc, wherein the wheel flange and the second end region define a groove, and wherein the wheel flange has a first recess by which the wheel rim is associated to the wheel disc by positioning the first end region in the first recess; and
an attaching element that attaches the wheel rim to the wheel disc, wherein the attaching element faces the inside of the groove.

2. A wheel according to claim 1, wherein the positioning of the first end region in the first recess configures an attaching region in the form of a recess for application of at least one attaching element.

3. A wheel according to claim 1, wherein the attaching element is a weld fillet.

4. A wheel according to claim 3, wherein the weld fillet receives a surface finish.

5. A wheel according to claim 4, wherein the surface finish of the weld fillet is a machined finish.

6. A wheel according to claim 1, wherein at least one of the wheel rim and the wheel disc are manufactured from carbon steel.

7. A substantially circular disc for use on a vehicle wheel, comprising:
a disc flange disposed around a perimeter of the disc, wherein the disc flange is associable to a substantially cylindrical wheel rim, wherein the disc flange has a first recess for association of the wheel rim, and wherein the disc flange faces a side to which the wheel rim is associable.

8. A disc according to claim 7, wherein the disc is manufactured from carbon steel.

9. A process for manufacturing a wheel, comprising:
manufacturing a substantially cylindrical wheel rim having a cylindrical wall and two opposite ends that are each substantially in the form of a rim flange, the first end being a first end region and the second end being a second end region, wherein the first end region and the second end region extend throughout the extension of the wheel rim;
manufacturing a substantially circular wheel disc having a wheel flange around its perimeter, wherein the wheel rim is concentrically associated with the wheel disc, wherein the wheel flange and the second end region define a groove, and wherein the wheel flange has a first recess by which the wheel rim is associated to the wheel disc by positioning the first end region in the first recess;
positioning and associating the wheel rim with the wheel disc with an attaching element, wherein the attaching element faces the inside of the groove.

10. A process according to claim 9, wherein the associating step comprises applying at least one weld fillet.

11. A process according to claim 10, further comprising machining the weld fillet.

12. A process according to claim 10, further comprising painting the wheel.

13. A process according to claim 9, wherein the step of manufacturing the wheel rim conducted by rolling and wherein the step of manufacturing the wheel disc is conducted by stamping.
